(19) United States
(12) Patent Application Publication
(10) Pub. No.: US 2003/0158859 A1
(43) Pub. Date: Aug. 21, 2003

(54) System and method for project log storage and retrieval

(76) Inventors: Peter Joel Lasensky, San Diego, CA (US); Mark Everett Fehrenbach, San Diego, CA (US)

Correspondence Address: TERRANCE A. MEADOR, GRAY CARY WARE & FREIDENRICH, LLP, 4365 EXECUTIVE DRIVE, SUITE 1100, SAN DIEGO, CA, 92121-2133, US

(21) Appl. No.: 10/384,408

(22) Filed: Mar. 6, 2003

Related U.S. Application Data
(63) Continuation of application No. 09/713,487, filed on Nov. 15, 2000.

(51) Int. Cl. G06F 7/00

(52) U.S. Cl. 707/104.1; 707/10

(57) ABSTRACT

A system and method of forming a project log for a project. A project includes a set of defined steps or states. An observation is made for each step or state of the project in a project management system. The observation is captured by a transmission device, which transmits data representing the observation. The data is received by a receive device. A computer receives the received data and converts the data into a digital file. One or more reference indicia, related to the received data by source identification, project identification, or other indication, is appended to the received data. The digital file is stored in a file storage, and the reference indicia are stored as tables in a database record in order to later access the digital file. By reference to at least one of the reference indicia, each digital file may be retrieved and accessed, for re-transmission or reproduction.

### BACKGROUND OF THE INVENTION

1. Field of the Invention

This invention relates broadly to the field of communications, and more particularly to a communication system and method for forming a project log.

2. Description of the Related Art

Many human endeavors can be “projectized,” that is, reduced to a systematic plan or design and undertaken as such. One example of a project is related to the construction industry, where a thing being constructed is conceptualized and reduced to a series of construction steps. Another example of a project is related to any service industry. For example, in medical-care services, a patient is diagnosed and treated according to a series of predefined medical steps.

One valuable aspect of projects is their characteristic of being able to be monitored and measured against a plan or design. For example, construction projects may be regularly monitored for progress toward completion of one or more construction plans. In one specific example, a superintendent of a construction project might monitor a project on a daily basis, and make a written entry into a log of his or her findings. In another specific example, a patient that requires extended medical care is monitored frequently, and his or her progress is memorialized in a written log known as the patient's record.

Various tools exist for managing projects. One example of such a tool is a computer-based software product called Contractor's Command Post™. A valuable feature of the Contractor's Command Post™ product is, in addition to tracking and managing project resources, its ability to compile a project log for a particular project. The project log is accessible for retrieving, analyzing, and adding observation information about a particular project. The project log provides useful information for fully managing a project that is completed step-by-step.

There are many mechanisms for forming and maintaining a project log. The simplest, and most common, mechanism is a written log, where a person who monitors a project makes a text-based entry into the log. Such written logs may be formed with a computer, or by hand with a pen and paper. Problems with a written log include the fact that text-based entry is tedious, leading to omissions in whole or in part. Hand writing, or even typing, can sometimes be difficult to comprehend and understand, and it is difficult to consolidate text entries into a master log file because some entries are misplaced, lost, or sometimes never made.

Another mechanism is to use a recording device for creating a log. The recording device may be a tape recorder or a video recorder, where the recording preserves a monitoring person's observations on a recording medium. Problems with conventional recording mechanisms are that a recording medium, such as a cassette tape, microcassette, or video cassette, can be lost or otherwise inaccessible. If they are accessible, it is usually only accessible to only one user or otherwise limited to a small number of persons who maintain a copy. Further, copies are difficult to reproduce and distribute effectively. Finally, conventional recordings are difficult to compile in a way that the recording media can be arranged in some logical, easily retrievable order.

What is needed is a system and method of forming a project log that leverages technological resources in a unique way, for efficient and cost effective recordation of observations that are related to a project.

### SUMMARY OF THE INVENTION

This invention relates to a communication system, and a related method thereof. This invention is useful for forming a project log, such as a daily record of observations, a recordation of meeting minutes, a to-do list, and the like.

According to one embodiment of the invention, a method of forming a project log for a project includes receiving an authorization request to access a database to create a record in the project log, and upon authorization, receiving data representing an observation relating to the project. The method further includes appending one or more reference indicia to the received data, storing the reference indicia as an entry in the database record, and storing the received data as a digital file which is accessible by reference to at least one of the reference indicia in the database record.

According to another embodiment of the invention, a system is provided for forming a project log for a project. The system includes a transmission device for transmitting data representing an observation, a receiving device configured to receive the transmitted data, and a computer in communication with the receiving device via a data communication interface, for creating and managing the project log. The computer further includes a processor configured to convert the received data to a digital file, and wherein the processor is further configured to generate one or more reference indicia associated with the data, a file storage connected to the processor that stores the digital file, and a database having a number of records that correspond to the project. The database is configured to store the one or more reference indicia in one or more of the of database records. The digital file is retrievable from the file storage by reference to one or more of the reference indicia.

### BRIEF DESCRIPTION OF THE DRAWING

FIG. 1 is a simplified block diagram of a system that is suitable for an embodiment of the invention.

FIG. 2 shows one embodiment of a system for forming a project log, according to the invention.

FIG. 3 illustrates another embodiment of a system for forming a project log.

FIG. 4 shows yet another alternative embodiment of a system for forming a project log, in accordance with the invention.

FIG. 5 shows yet another alternative embodiment of a system for forming a project log.

FIG. 6 illustrates one method of forming a project log according to the invention.

### DETAILED DESCRIPTION OF THE PREFERRED EMBODIMENTS

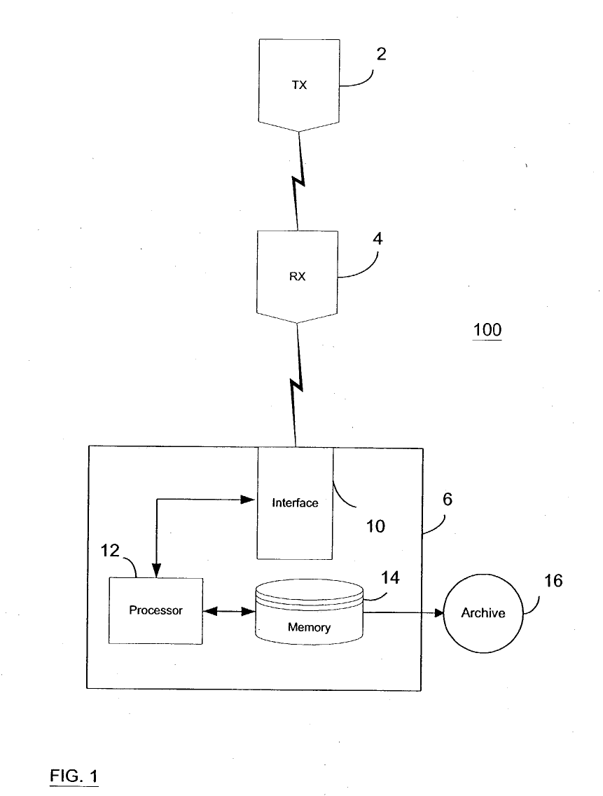

FIG. 1 shows a system 100 that is suitable for forming a project log according to the invention. The system 100 includes a transmission device 2 for transmitting data and a receiving device 4 for receiving the data. Those having skill in the relevant art would recognize that designations used herein for the transmission and receiving devices are relative, and as such are not meant to limit such devices to having one specific functionality. For example, the transmission device 2 may be a cellular phone having two-way radio functionality, in which the transmission device is also able to receive incoming transmissions. Likewise, the receiving device 4 may also be a two-way device having both receive and transmission capabilities. Other embodiments will illustrate various examples of the transmission and receive devices 102, 104.

The data being transmitted, in accordance with the invention, represents an observation associated with a specific project. An observation includes a single observation event, or a collection of observation events. The observation may also be represented in a digital or analog recording of an inspection of the project, for example. The observation may also be represented as an event in which a person speaks into a cellular phone, radio or other transmission device or video, tape recording, or video recording device, at the time of observing a project. In such cases, the data being transmitted represents a real time, or near-real time, observation by one or more persons, and the data may be formed and transmitted in as close a time to the observation as desirable.

The system 100 further includes a computer 6. In accordance with the invention, the computer 6 includes a data communication interface 10 for communication with the receiving device 4 to receive data transmitted by the transmitting device 2. The computer 6 also includes a processor 12 configured to convert the received data into a digital file format, generate one or more reference indicia associated with the data, and append the reference indicia to the digital file.

The digital file format can be a WAV file if the data is audio or voice data, or another digital format depending on the format and type of data being transmitted. The digital file may ultimately be stored as a compressed digital file, such as an MPEG-1, audio layer-3 (MP3) file used for compressing sound sequences to roughly one-twelfth the original size of the file. Other compression techniques for other types of data may suitably be used. The reference indicia includes time, date, or duration of the monitoring event, time, date, or duration of the digital representation of the monitoring event or the recording thereof. The reference indicia could also include a job identification, such as job number, type, or other information relating to a job, such as name, code- or pseudo-name.

The computer 6 further includes a memory 14 connected to the processor 12, for storing the digital file. The memory includes a database, such as a relational or object-oriented database, for referencing the digital file that is stored in another portion of the memory 14. The memory 14 is represented in FIG. 1 as a single block, however, it may also be implemented as a distributed or parallel memory subsystem. Further, the memory 14 may be external to the computer 6 and connected to the processor via a network connection, for example. An archive 16 is connected to the memory 14 and provides for long-term storage and access of a collection of digital files. The digital files may be transferred directly from the memory 14 or indirectly via temporary storage mechanism.

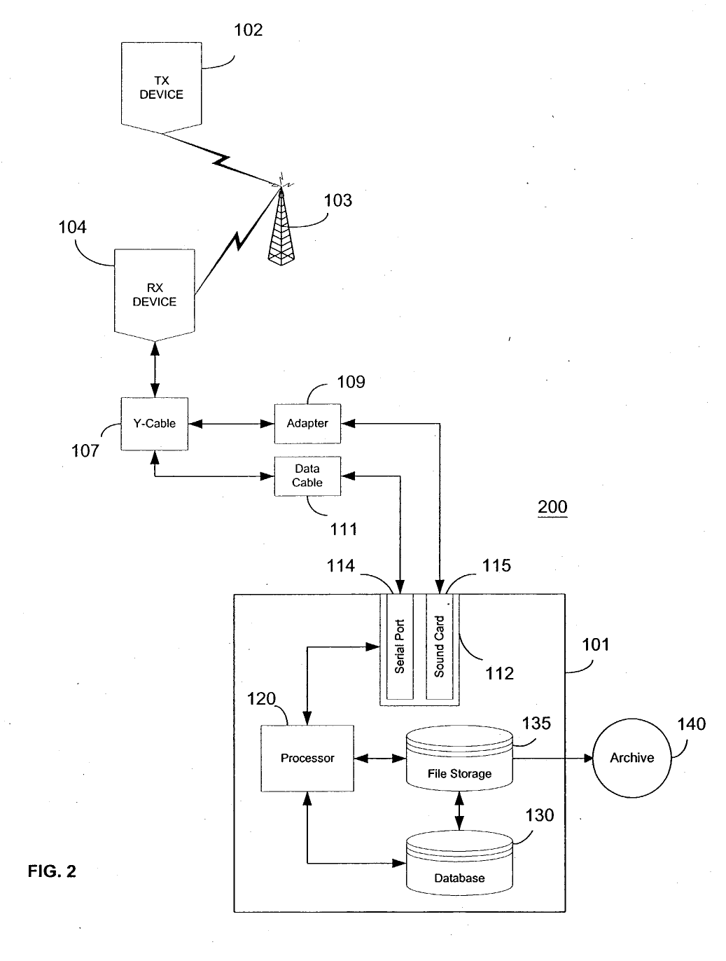

FIG. 2 shows a specific embodiment of a system 200 according to the invention. In the specific embodiment, a transmission device 102 and a receive device 104 are wireless devices communicating to each other via a wireless network 103. In an exemplary embodiment, the transmission device 102 is a two-way cellular radio. One type of two-way cellular radios is known as a Direct Connect™ radio sold by Nextel Inc., and provided as a function on a Nextel cellular phone. Another type of two-way radio is the IDEN™ phone, sold by Motorola Inc. In the specific embodiment, the transmission device 102 uses the radio frequency spectrum to establish a direct radio link to the receiving device 104, which can also be a two-way cellular radio. The link from transmission device 102 to receiving device 104 may be formed via a cellular network 103.

In the exemplary embodiment shown in FIG. 2, a data communication interface 112 includes a serial port 114 and a sound card 115. The serial port 114 is connected to a data cable 111 to form a control channel, for transmitting control data and instructions between the receiving device 104 and the computer 101. The sound card 115 is connected to an adapter 109 to form a data channel, and is configured to receive audio data from the receiving device 104. A Y-cable 107 is used to connect the both the control and data channels to the receiving device 104.

The transmission device 102 transmits data representing an observation related to a project. A receive device 104 receives the transmitted data. A computer 101 is connected to the receive device 104, and receives the data from the receive device 104 via the data communication interface 112, as described above. A processor 120 in the computer 101 receives the data and generates one or more reference indicia related to either the observation, the received data, or both. The processor 120 further converts the received data to a digital file. The digital file is preferably in a format that can be easily stored and compressed, if necessary.

In one embodiment, the processor 120 is a central processing unit (CPU) of the computer 101. In an alternative embodiment, the processor 120 includes a digital signal processor (DSP), such as may be formed in an application specific integrated circuit (ASIC) that is typically included in either the serial port 114 or the sound card 15. The processor may therefore have a distributed processing architecture, configured to perform the functions described above.

The digital data file is stored in a file storage 135. The related reference indicia are stored as tables in one or more records in a database 130. In one embodiment of the invention, the processor 120 first converts the digital file to a compressed digital file, and then stores the compressed digital file in the file storage 135. An archive 140 is provided for long-term storage and retrieval of the digital files and/or associated database records.

The file storage 135 may be any type of storage media, such as digital storage or even analog storage for storing digital content. The database 130 may be formed of any type of memory, such as a hard disk drive or other digital medium. Each database record includes one or more tables in which the reference indicia may be logically stored. The database 130 can be a single database, or a distributed collection of databases linked together across a network. Each entry in the database record in the database 130 corresponds to a project log of a project.

A project log is the collection of information contained in all database records related to a project. By storing the reference indicia into one or more accessible database records, each digital file may be accessed from the file storage 135, and a digital project log is thus formed. The digital files and the records of the project log may be retrieved for further transmitting, such as over a network via electronic mail, for example. Or the digital files and the records may be retrieved for accessing and modifying the data contained in the digital files.

Table 1 illustrates an example table included in a database record. The table includes employee information for employees who are authorized to access the database, according to a preferred embodiment of the invention. Table 1 is exemplary only, and the contents illustrated therein should not be used to limit the database or tables to storing a particular set of information. In the example, each authorized employee is identified by name, address, salary, SSN etc. The specific fields in the table and the types of information are company specific.

TABLE 1

| Name | Number | SSN | Address | Phone | Salary | Cell Id |
|---|---|---|---|---|---|---|
| Joe | 00001 | 123-65-4321 | 456 | 7145551111 | 20000 | 10001 |
| Smith | | | B St. | | | |
| Jane | 00002 | 123-45-1111 | 123 | 8585551234 | 50000 | 10002 |
| Doe | | | A St. | | | |
| John | 12345 | 123-45-6789 | 123 | 8585551234 | 30000 | 10003 |
| Doe | | | A St. | | | |

Table 2 shows an authorization table for the same database record. The authorization table is used to map an observer or transmitter of data into a specific project log database record. There can be more than one project log authorized for each identification. For example, Cell Id 10002 is a cell phone identification number which belongs to Jane Doe. Cell Id 10002 maps to a “To Do list” project if she calls 10100, and maps to a “Remodel” project if she calls 10101.

TABLE 2

| Cell Id | Job Log Name | Job Log Id |
|---|---|---|
| 10002 | Personal To Do List | 10100 |
| 10002 | Empire State Building Remodel | 10101 |
| 10003 | Personal To Do List | 10100 |

Table 3 shows another table for the project log database record. Table 3 is used to track the filename of the received data, such as a recorded call, the caller id of the call, date, time and duration of the call, etc. Each project log will have one entry in the database record for each received and recorded call.

TABLE 3

| Caller Id | Filename | Date | Time | Duration |
|---|---|---|---|---|
| 10002 | 10002Remodel | Oct. 24, 2000 | 13:15:30 | 30 sec |
| 10002 | 10002ToDo1 | Oct. 24, 2000 | 13:20:01 | 10 sec |
| 10002 | 10002ToDo2 | Oct. 24, 2000 | 14:30:02 | 15 sec |
| 10003 | 100033ToDo1 | Oct. 25, 2000 | 08:30:05 | 30 sec |

Tables 1-3 therefore store reference indicia that are related to received data, which is in turn a representation of an observation. The data is stored as a digital file in a file storage. All the digital files that relate to a project form a portion of a project log. The reference indicia are stored as tables in a database record to access and retrieved stored files.

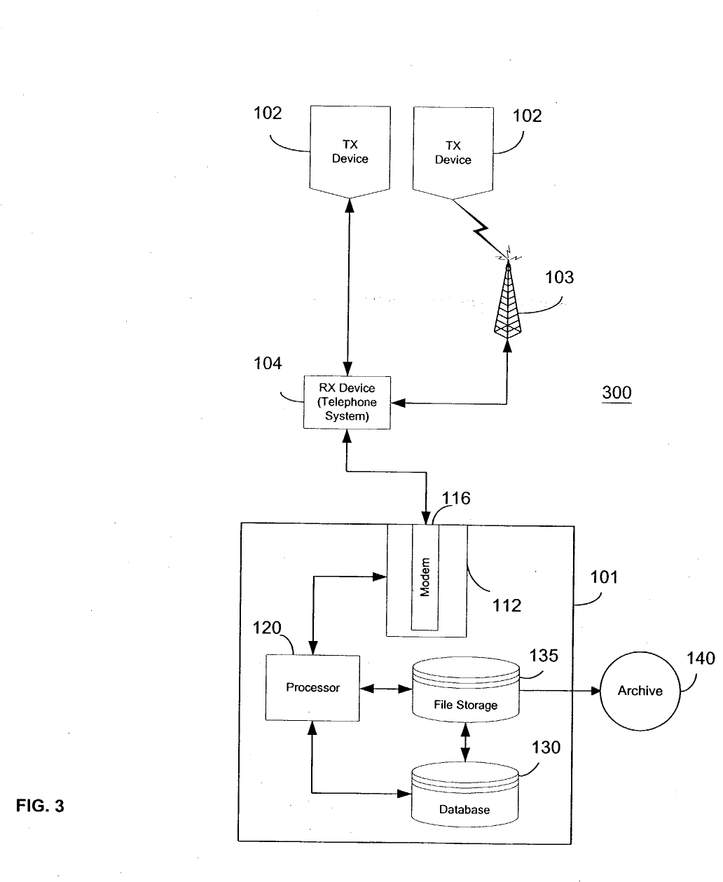

FIG. 3 illustrates a system 300 for forming a project log according to an alternative embodiment of the invention. In the system 300, the data communication interface 112 to the computer 101 includes a modem 116 configured to communicate with a telephone system that functions as the receiving device 104. In one embodiment, the telephone system is known as the plain-old telephone system (POTS) through which conventional telephone signals are communicated via standard twisted-pair wire cable. In this embodiment, the transmitting device 102 is a telephone. In another embodiment, the transmitting device 102 is a cellular telephone, that is connected to the receiving device 104 via a cellular network 103.

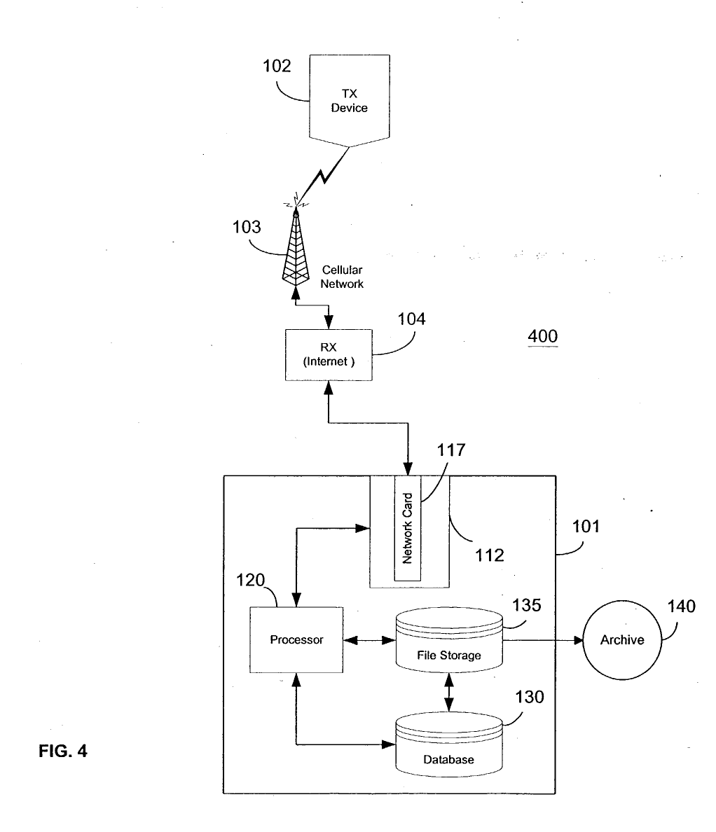

FIG. 4 shows yet another alternative embodiment of the invention. A system 400 includes a computer 101 having a data communication interface 112, as substantially described above. The data communication interface 112 includes a network card 117 configured for communication with a network, such as the Internet, a portion of which acts as the receiving device 104. The transmission device 102 communicates to the receiving device via cellular network 103, which forwards digital cellular signals from the transmitting device 102.

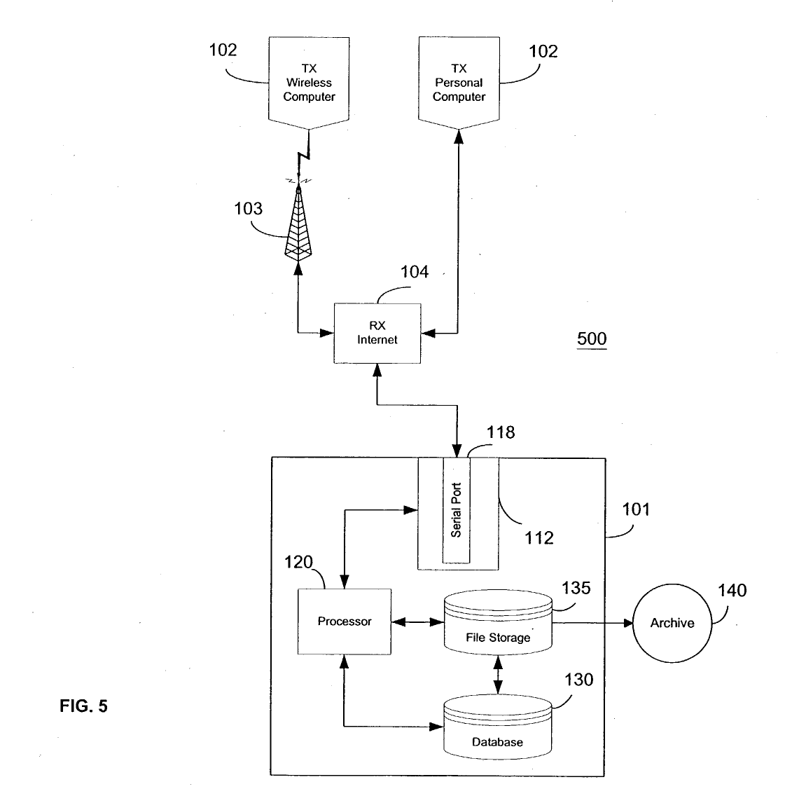

FIG. 5 shows still yet another system 500 for forming a project log, in accordance with alternative embodiment of the invention. In system 500, the data communication interface 112 includes a network card 118 for communication with the network. At least a portion of the network acts as the receiving device 104. Suitable transmission devices 102 for the embodiment shown in system 500 include a personal computer (PC), a wireless computer, such as a portable PC having wireless capabilities or a handheld personal digital assistant (PDA), connected to the receiving device 104 via a cellular network 103.

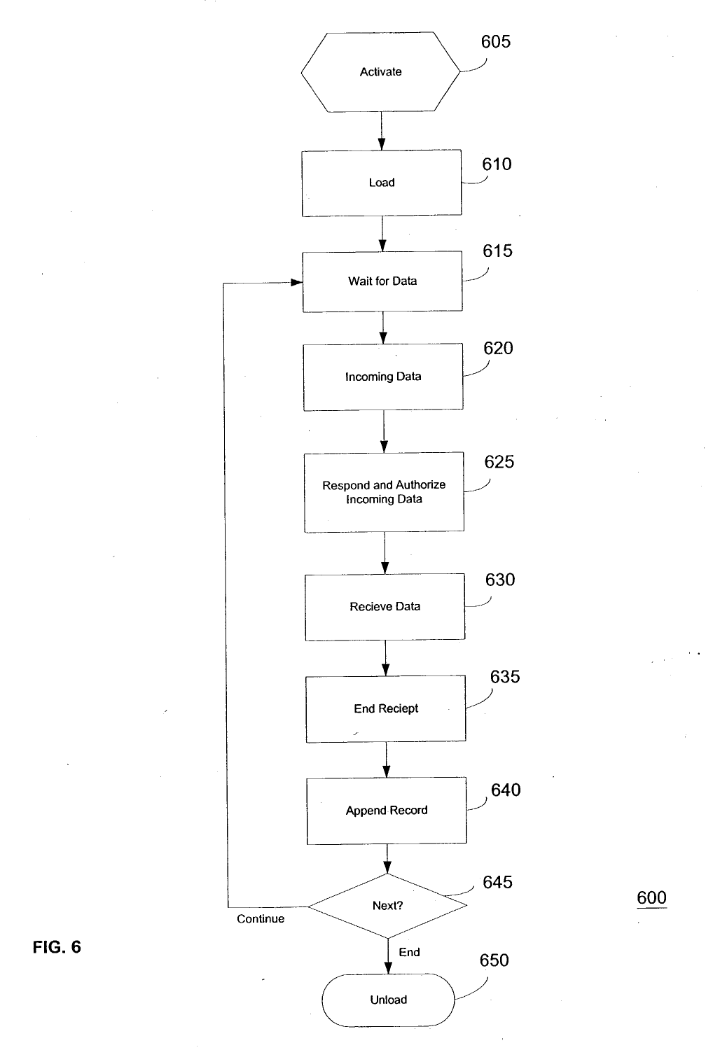

FIG. 6 illustrates one method 600 of forming a project log according to the invention. The method 600 is preferably executed on one of the systems described with reference to FIGS. 1-4 above, however execution of such method need not be so limited. Thus, any system or apparatus which can perform the method described herein may be suitably used and still be within the scope of the present invention.

Method 600 begins at process block 605, in which global variables are initialized within software commands the processor and controls the forming of a project log. The process block 605 thus activates a process for receiving data. According to one method of the invention, at process block 610 a plurality of multimedia control objects (MMControl) are loaded, which set up a computer for communication with the transmission device through the receive device. Process block 610 is used to initialize an audio or video recording device through MMControl. In one specific embodiment, at process block 610 a bank of cellular telephones, having a two-way radio capability and acting as transmission and/or receive devices, are initialized and connected to enable direct messaging to the computer.

At process block 615 in the method 600, a wait period is executed to wait for data being transmitted and received. At process block 620, an authorization request is received as incoming data. In an exemplary embodiment, the authorization request includes a member identification number from one member of a group of mobile phone users. The identification number is looked up in a table that is part of a database of numbers. If the user is authorized to access the project log, then an authorization is given at process block 625. The identification number, along with the date and time of receipt of the authorization, is used to create a new record, including a filename for the newly created record. In one embodiment, the filename will be appended to received data, and stored as a reference indication in the database.

Upon authorization, the communication link from the computer 101 to the relevant transmitting device 102 is in a state for being ready to carry data. At process block 630, data representing an observation is received. As stated above, the data may be in any form, including in digital or analog format. Examples of analog data that are suitable for the invention are voice signals from a two-way radio, cellular phone, or conventional telephone. Digital data includes digital signals sent from a digital phone or a computer. According to one specific example, an observer speaks into a cellular radio that acts as a transmission device. The voice signals are transmitted to a second cellular radio that acts as a receive device.

The data is received until process block 635, when the transmission of data is stopped, and the receipt of data is accomplished. At block 635, the step of processing the received data is accomplished. For example, the voice signals from the receive device are received as an audio stream by a computer and processed into a sound clip, or other digital file. At block 635, all properties of the system are set in order to stop receiving and recording incoming data. The received data is set for being appended with reference indicia, and a duration of time in which the data was received is calculated.

At process block 640, various database routines are called to open the authorized database records and insert the data in a new or existing record. Information that describes the data is also inserted. The record is then appended with reference indicia, which may include, but is not limited to, duration, sender identification, date, time, and filename. At step 645, a decision is made whether to execute an instruction to continue the process, or to end the method. If the process continues, the method returns to process block 615 to wait for more data. If no more data is to be received, an unload step is executed at process block 650 to deactivate incoming communication links and switch all communication devices to an inactive state.

Those skilled in the art would recognize that each embodiment of the project log forming system discussed above may be combined with other like embodiments or different embodiments. For example, the system shown in FIGS. 1-4 may be implemented with a bank of parallel data communication interfaces 112 configured for connection to a plurality of transmission devices 102.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

We claim:

1. A method of forming a project log for a project, comprising:
receiving a request for authorization to create a database record;
upon authorization, receiving data representing an observation relating to the project;
appending one or more reference indicia to the received data;
storing the reference indicia as an entry in the database record; and
storing the received data as a digital file which is accessible by reference to at least one of the reference indicia in the database record.

2. The method of claim 1, wherein the authorization request includes an identification of a sender of said data.

3. The method of claim 1 wherein the data representing an observation includes video signals of an observer from a video signal transmission device.

4. The method of claim 1 wherein the data representing an observation includes audio signals of an observer from an audio signal transmission device.

5. The method of claim 4 wherein the audio signals include radio frequency signals and the audio signal transmission device is a two-way radio.

6. The method of claim 4 wherein the audio signal transmission device is a cellular phone.

7. The method of claim 4 wherein the audio signal transmission device is a telephone.

8. The method of claim 4 wherein the audio signal transmission device is a computer.

9. The method of claim 1, wherein the reference indicia include a time of receipt of the data.

10. The method of claim 1, wherein the reference indicia include a date of receipt of the data.

11. The method of claim 1, wherein the reference indicia include a project identification.

12. The method of claim 4, wherein the digital file is an audio clip.

13. The method of claim 1, wherein the storing further includes converting the received data to a WAV file.

14. The method of claim 13, wherein the storing further includes converting the WAV file to a MP3 compressed format.

15. The method of claim 1, wherein the storing said data further includes storing said appended reference indicia with said data.

16. The method of claim 1, further comprising transmitting, upon expiration of an interval in which data is not received, a solicitation for monitoring event data.

17. The method of claim 1, further comprising retrieving said stored digital file upon valid reference to one or more reference indicia.

18. The method of claim 17, further comprising transmitting the retrieved digital file to a user from whom the one or more reference indicia is received.

19. The method of claim 18, wherein the transmitting includes sending the data via electronic mail.

20. The method of claim 18, wherein the transmitting includes sending the data via the internet.

21. A system for forming a project log for a project, comprising:
a transmission device for transmitting data representing an observation;
a receiving device configured to receive the transmitted data; and
a computer in communication with the receiving device via a data communication interface, wherein the computer further comprises:
a processor configured to convert the received data to a digital file, and wherein the processor is further configured to generate one or more reference indicia associated with the data;
a file storage connected to the processor that stores the digital file; and
a database having a plurality of records that correspond to the project, the database being configured to store the one or more reference indicia in one or more of the plurality of database records, and wherein the digital file is retrievable from the file storage by reference to one or more of the reference indicia.

22. The system of claim 21, wherein the transmission device includes a cellular radio.

23. The system of claim 21, wherein the transmission device includes a telephone.

24. The system of claim 21, wherein the transmission device includes a computer.

25. The system of claim 22, wherein the receiving device includes a cellular radio.

26. The system of claim 21, wherein the receiving device forms a part of the internet.

27. The system of claim 21, wherein the receiving device forms a part of a central office of the telephone system.

28. The system of claim 21, wherein the data communication interface is selected from a group of interfaces including: a serial port, a sound card, a modem, or a network card.

29. The system of claim 21, wherein the data includes audio.

30. The system of claim 21, wherein the reference indicia is text.

31. The system of claim 21, wherein the observation is a real time or near-real time observation of the project by an observer.
